(19) United States
(12) Patent Application Publication
(10) Pub. No.: US 2026/0216939 A1
(43) Pub. Date: Jul. 30, 2026

(54) FILM CONVEYANCE MACHINE, FILM CONVEYANCE METHOD, AND FILM MANUFACTURING APPARATUS

(71) Applicant: THE JAPAN STEEL WORKS, LTD., Shinagawa-ku, Tokyo (JP)

(72) Inventor: Tomoki SAWADA, Shinagawa-ku, Tokyo (JP)

(21) Appl. No.: 19/144,159

(22) PCT Filed: Oct. 6, 2023
(86) PCT No.: PCT/JP2023/036483

§ 371 Date: Jun. 27, 2025

(30) Foreign Application Priority Data
Jan. 17, 2023 (JP) 2023-004857

(51) Int. Cl. B29C 48/355; B29C 48/00; B29C 48/08; B29C 48/88; B29C 48/92; B29L 7/00; B65H 20/02; B65H 23/04

(52) U.S. Cl. CPC B29C 48/355; B29C 48/0018; B29C 48/08; B29C 48/914; B29C 48/92; B65H 20/02; B65H 23/046; B65H 23/048; B29C 2948/92076; B29C 2948/92171; B29C 2948/92428; B29C 2948/92438; B29C 2948/9259; B29C 2948/92923; B29L 2007/008

(57) ABSTRACT

A film conveyance machine and the like that automatically feed a film can be provided. A film conveyance machine feeds a film (83) from an upstream side to a downstream side. The film conveyance machine includes a feed mechanism (70) including a robot arm (715) that includes a conveyor (711) on a lower side of a tip part of the robot arm, and a lower roll base (720) that is provided below the conveyor and includes a plurality of rolls. The feed mechanism (70) may be configured to cause the lower roll base to move up, to thereby place a film fed from the upstream side on the lower roll base, and cause the robot arm to move the tip part thereof down, to thereby convey the film toward the downstream side by rotation of the conveyor while the film is grasped between the conveyor and the lower roll base.

### TECHNICAL FIELD

The present invention relates to a film conveyance machine, a film conveyance method, and a film manufacturing apparatus.

### BACKGROUND ART

Patent Literature 1 discloses a stretching machine that conveys an extruded film and stretches the film, and a clip apparatus that holds the film by clips.

### CITATION LIST

### Patent Literature

[Patent Literature 1] Japanese Unexamined Patent Application Publication No. 2012-187788

### SUMMARY OF INVENTION

A film cannot be fed between a longitudinal stretching area and a lateral stretching area, and therefore an operation for feeding the film has been manually performed by a plurality of persons. Such a manual operation is troublesome and inefficient.

The present disclosure has been made in order to solve the above-described problem and an object thereof is to provide a film conveyance machine and the like that automatically feed a film.

A film conveyance machine according to one embodiment is a film conveyance machine configured to feed a film from an upstream side to a downstream side, the film conveyance machine including a feed mechanism that includes:
a robot arm including a conveyor on a lower side of a tip part of the robot arm; and
a lower roll base that is provided below the conveyor and includes a plurality of rolls.

A film conveyance method according to an embodiment is a film conveyance method for feeding a film from an upstream side to a downstream side by using a film conveyance machine including a robot arm that includes a conveyor on a lower side of a tip part of the robot arm, and a lower roll base that is provided below the conveyor and includes a plurality of rolls, the film conveyance method including:
causing the lower roll base to move up, thereby placing the film fed from the upstream side on the lower roll base; and
causing the robot arm to move down, thereby conveying the film toward the downstream side by rotation of the conveyor while the film is grasped between the conveyor and the lower roll base.

A film manufacturing apparatus according to an embodiment includes:
an extruder configured to melt a charged resin raw material and extrude the molten resin raw material;
a die coupled to the extruder, the die being configured to mold a molten resin into a film shape;
a cooling roll configured to cool the film-like molten resin extruded from the die and discharge a resin film obtained by solidification of the molten resin;
a longitudinal stretching machine provided downstream of the cooling roll, the longitudinal stretching machine being configured to longitudinally stretch a film and feed the film toward a downstream side;
a feed mechanism configured to feed the film to the downstream side, the feed mechanism including a robot arm that includes a conveyor on a lower side of a tip part of the robot arm, and a lower roll base that is provided below the conveyor and includes a plurality of rolls; and
a lateral stretching machine provided downstream of the feed mechanism, the lateral stretching machine being configured to laterally stretch a film and feed the film toward the downstream side.

According to an embodiment of the present disclosure, it is possible to provide a film conveyance machine that automatically feeds a film.

### BRIEF DESCRIPTION OF DRAWINGS

FIG. 1 is a schematic perspective view showing an overall configuration of a film conveyance machine and a film manufacturing apparatus according to a first embodiment;

FIG. 2 is a schematic perspective view showing a configuration of a film feed mechanism according to the first embodiment;

FIG. 3 is a schematic perspective view showing an operation of a film feed mechanism according to the first embodiment;

FIG. 4 is a schematic perspective view showing a film feed mechanism and a clip apparatus according to another embodiment;

FIG. 5 is a top view for explaining an operation for stretching wrinkles by a belt conveyor; and

FIG. 6 is a top view for explaining an operation for stretching wrinkles by the belt conveyor.

### DESCRIPTION OF EMBODIMENTS

Specific embodiments will be described hereinafter in detail with reference to the drawings. However, the present disclosure is not limited to the following embodiments. Further, for the clarification of the description, the following descriptions and drawings are simplified as appropriate.

### First Embodiment

### Overall Configuration of Film Manufacturing Apparatus

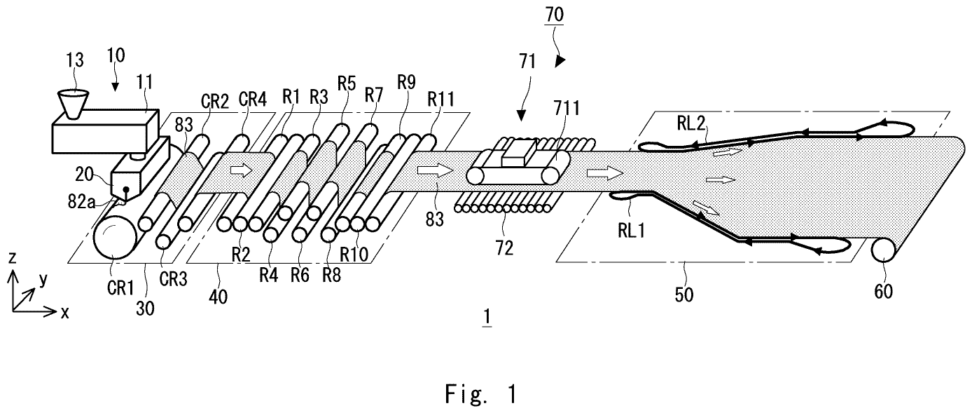

First, an overall configuration of a film manufacturing apparatus including a resin film conveyance machine according to a first embodiment will be described with reference to FIG. 1. FIG. 1 is a schematic perspective view showing the overall configuration of the film manufacturing apparatus according to the first embodiment.

Note that xyz orthogonal coordinates shown in FIG. 1 and other drawings are shown only for the sake of convenience to explain positional relations among the components. Normally, the z-axis positive direction is a vertically upward direction, and the xy plane is a horizontal plane, which direction and plane are the same throughout the drawings. Further, in this specification, a film may be a resin film and may include a resin sheet.

As shown in FIG. 1, a film manufacturing apparatus 1 includes an extruder 10, a T-die 20, a cooler 30, a longitudinal stretching machine 40, a feed mechanism 70, a lateral stretching machine 50, and a winder 60. The film manufacturing apparatus according to the first embodiment is an extrusion-molding type film manufacturing apparatus that extrudes a film-like molten resin 82a from a gap between lips of the T-die 20 coupled to the extruder 10. Note that, in FIG. 1, details of a robot mechanism 71 and a lower roll mechanism 72 are not shown.

The extruder 10 shown in FIG. 1 is a screw type extruder. In the extruder 10, a screw extended in the x-axis direction is accommodated in a cylinder 11 extended in the x-axis direction. A hopper 13 for charging resin pellets, which are raw materials of a resin film 83, is provided on an upper side of an end part of the cylinder 11 in the x-axis negative direction.

The resin pellets supplied from the hopper 13 are conveyed from a root of the rotating screw to a tip thereof, that is, conveyed in the x axis positive direction. Further, the resin pellets are heated, sheared by the rotating screw inside the cylinder 11 and melted, and transformed into a molten resin 82.

Note that, although not shown, for example, a motor is coupled to the screw as a driving source through a speed reducer,. Further, a heater for heating the inside of the cylinder 11 is provided on an outer peripheral surface of the cylinder 11 over substantially the entire longitudinal direction thereof, and the resin pellets charged into the inside of the cylinder 11 are heated.

As shown in FIG. 1, the T-die 20 is coupled to a lower side of a tip part (an end part on the x-axis positive direction side) of the extruder 10. The film-like molten resin 82a is extruded downward (in the z-axis negative direction) from the gap between the lips of the T-die 20 located at the lower end thereof. Note that a lip gap of the T-die 20 can be adjusted. The lip gap of the T-die 20 can be adjusted at a plurality of positions along the longitudinal direction (the y-axis direction) of the lip so that the thickness of the resin film 83 to be manufactured becomes uniform in the width direction thereof (the y axis direction).

As shown in FIG. 1, the cooler 30 includes cooling rolls CR1 to CR4.

The cooling roll CRI cools the film-like molten resin 82a extruded from the T-die 20 and discharges the resin film 83 obtained by solidification of the film-like molten resin 82a to the cooling roll CR2. The cooling roll CR1 is also referred to as a cast roll.

Then, as shown in FIG. 1, the cooling rolls CR2 to CR4 cool the resin film 83 and convey it in this order. Each of the cooling rolls CR1 to CR4 may be a driving roll driven by a driving source (not shown). The driving source is a variable-speed motor such as a servomotor.

Note that each of the cooling rolls CR1 to CR4 may include a cooling mechanism for cooling the resin film 83. Each of the cooling rolls CR1 to CR4 may also include a heating mechanism for heating the resin film 83. Since the cooler 30 includes a plurality of driving rolls for conveying the resin film 83, it may be one form of the film conveyance machine according to this embodiment.

As shown in FIG. 1, the longitudinal stretching machine 40 stretches the resin film 83 discharged from the cooler 30 in the longitudinal direction while conveying it. The longitudinal stretching machine 40 shown in FIG. 1 includes 11 rolls R1 to R11. Each of the rolls R1 to R11 is a driving roll driven by a driving source (not shown). The driving source is a variable-speed motor such as a servomotor. The longitudinal stretching machine 40 is one form of the film conveyance machine according to this embodiment.

Note that the longitudinal stretching machine 40 only needs to include a plurality of driving rolls for conveying the resin film 83, and the number of driving rolls included in the longitudinal stretching machine 40 and positions of the driving rolls are determined as appropriate. Further, each of the rolls R1 to R11 may include at least one of the cooling mechanism for cooling the resin film 83 and the heating mechanism for heating the resin film 83. The longitudinal stretching machine 40 may also include one or more nip rolls for pressing the resin film 83 against one of the rolls R1 to R11. The nip rolls are not the driving rolls. Note that, in a film conveyance route, an area where the film is longitudinally stretched by the longitudinal stretching machine 40 is also referred to as a longitudinal stretching area.

The feed mechanism 70 automatically feeds the resin film 83 discharged from the longitudinal stretching machine 40 to the lateral stretching machine 50 at the subsequent stage. Since the longitudinal stretching machine 40 and the lateral stretching machine 50 have different feed mechanisms, a manual operation performed by a plurality of persons has been required to feed the resin film 83 discharged from the longitudinal stretching machine 40 to the lateral stretching machine 50 at the subsequent stage. However, since this operation is troublesome and inefficient, the film feed mechanism 70 having a function of grasping a film and a function of feeding the film is newly provided in the present disclosure. Details of this feed mechanism 70 will be described later. The feed mechanism 70 may be one form of the film conveyance machine according to this embodiment.

The lateral stretching machine 50 stretches the resin film 83 discharged from the feed mechanism 70 in the width direction thereof (the y-axis direction). More specifically, the lateral stretching machine 50 includes a pair of rails RL1 and RL2. Further, a number of clips (not shown) are slidably arranged in parallel in the entire rails RL1 and RL2.

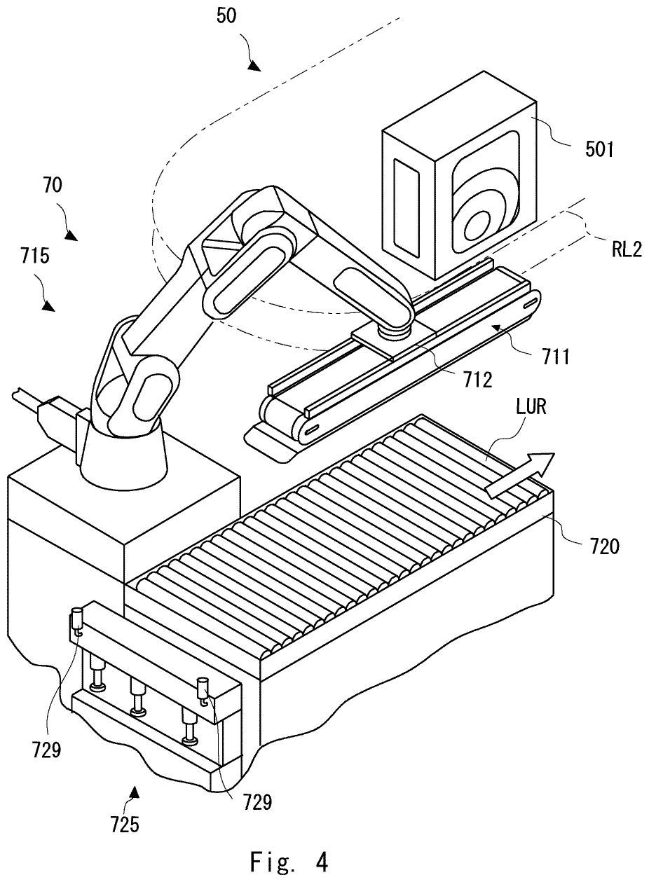

In FIG. 1, an arrow shown in each of the rails RL1 and RL2 indicate a direction in which the clips are moved. As shown in FIG. 1, each of the rails RL1 and RL2 has a loop structure having an outward route in which the clips move in a conveyance direction of the resin film 83 (the x-axis positive direction) and a return route in which the clips move in a direction opposite to the conveyance direction (the x-axis negative direction). That is, in the lateral stretching machine 50, the clips circulate along the rails RL1 and RL2 each of which has the loop structure. Although not shown in FIG. 1, clip closers (501 shown in FIG. 4) close tenter clips on the film. As shown in FIG. 1, the rails RL1 and RL2 are symmetrical with respect to a plane parallel to the xz plane.

As shown in FIG. 1, both the rails RL1 and RL2 are provided in substantially parallel with each other in the outward route in which the clips move in the conveyance direction (the x-axis positive direction) and the return route in which the clips move in the direction opposite to the conveyance direction (the x-axis negative direction). The return route of the rail RL1 is provided on the outside of the resin film 83 in the width direction thereof (the y-axis negative direction side).

Similarly, the return route of the rail RL2 is provided on the outside of the resin film 83 in the width direction thereof (the y-axis positive direction side).

As shown in FIG. 1, the outward route of each of the rails RL1 and RL2 includes a pair of parallel parts parallel to the x-axis at both ends thereof in the longitudinal direction (the x-axis direction), and an oblique part oblique in the y-axis direction between the parallel parts. The oblique part of the rail RL1 is obliquely disposed in the y-axis negative direction, and the oblique part of the rail RL2 is obliquely disposed in the y-axis positive direction. That is, in the oblique parts of the outward routes of the rails RL1 and RL2, a distance between the rails RL1 and RL2 in the y-axis direction increases toward the x-axis positive direction.

Note that, in the outward routes of the rails RL1 and RL2 shown in FIG. 1, at the parts thereof where the resin film 83 is in contact with the clips, the clips move along the rails RL1 and RL2 in the x-axis positive direction while grasping both ends of the resin film 83 in the width direction thereof (the y-axis direction). Therefore, as shown in FIG. 1, in the oblique parts of the outward routes of the rails RL1 and RL2, the resin film 83 is stretched in the width direction thereof (the y-axis direction) while being conveyed in the x-axis positive direction. Meanwhile, in the parallel parts of the outward routes of the rails RL1 and RL2, the resin film 83 is only conveyed in the x-axis positive direction and not stretched in the width direction thereof (the y-axis direction).

The lateral stretching machine 50 shown in FIG. 1 includes a driving source for driving the clips for conveying the resin film 83. The driving source is a variable-speed motor such as a servomotor. The lateral stretching machine 50 may be one form of the film conveyance machine according to this embodiment.

The resin film 83 discharged from the lateral stretching machine 50 is wound by the winder 60. The winder 60 is a driving roll driven by a driving source (not shown). Note that the winder 60 may include a plurality of driving rolls driven by driving sources. In this case, the winder 60 may be one form of the film conveyance machine according to this embodiment. Note that, in a film conveyance route, an area where the film is laterally stretched by the lateral stretching machine 50 is also referred to as a lateral stretching area.

As described above, in the film conveyance machine according to this embodiment, each of some or all of the cooler 30, the longitudinal stretching machine 40, the feed mechanism 70, the lateral stretching machine 50, and the winder 60 may be one form of the film conveyance machine according to this embodiment.

### Overall Configuration of Feed Mechanism

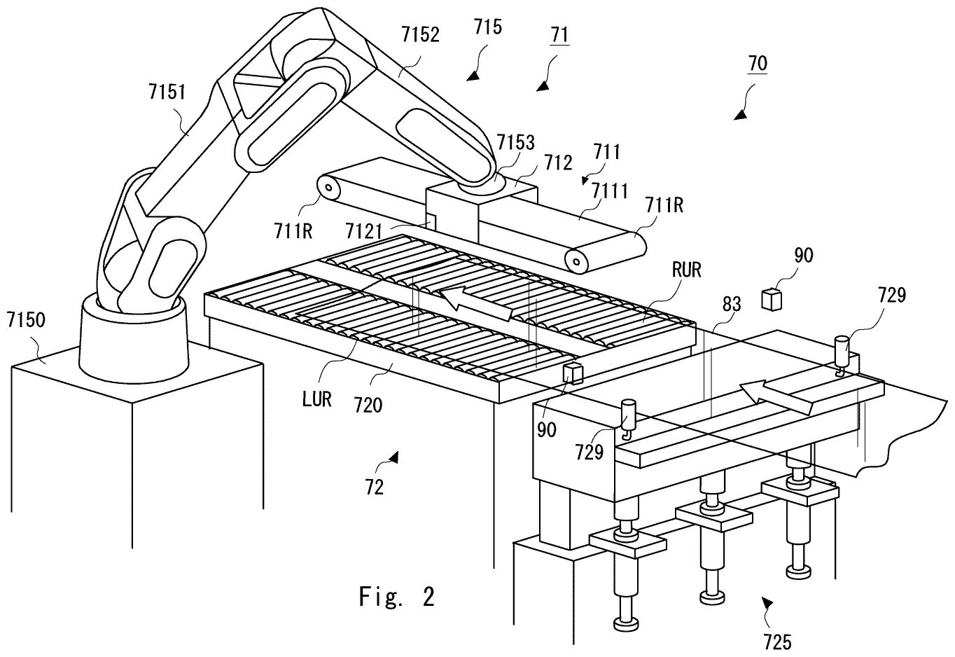

FIG. 2 is a schematic perspective view showing a configuration of a film feed mechanism. As an example, the feed mechanism 70 may be provided downstream of the longitudinal stretching machine 40 and upstream of the lateral stretching machine 50 in a film conveyance route.

The feed mechanism 70 includes a robot arm 715 including a belt conveyor 711 on a lower side of a tip part thereof, and a lower roll base 720 that is provided under the belt conveyor 711 and includes a plurality of rolls, which lower roll base can move up and down. The lower roll base 720 can move up and down in a vertical direction by an elevation mechanism 725. In FIG. 2, the elevation mechanism 725 includes three elevation units that can move up and down in synchronization with each other. The lower roll base 720 includes a plurality of lower right rolls RUR and lower left rolls LUR arranged in two rows so that a film can be placed thereon and then fed.

The robot arm 715 may be a six-axis vertical articulated robot arm. The robot arm 715 includes a base part 7150 fixed over the floor, a first link 7151 provided in the base part 7150 so as to be rotatable and tiltable, a second link 7152 provided in a tip part of the first link 7151 so as to be tiltable, and a wrist part 7153 provided in a tip part of the second link 7152 so as to be tiltable. Various types of known robot arms may be used as the robot arm.

The belt conveyor 711 is connected to the tip part of the robot arm 715 through an attachment part 712. The belt conveyor 711 includes a plurality of rolls 711R and 711R provided at respective ends thereof, and a belt 7111 laid over the plurality of rolls. Each of the rolls 711R is a roll with a built-in motor. Various types of known belt conveyors may be used as the belt conveyor.

Guide rolls 729 and 729 for guiding a film fed from the longitudinal stretching machine 40 are provided. Further, two meandering detection units 90 are provided after the guide rolls 729 and 729. One or more of the meandering detection units 90 may be disposed immediately after the longitudinal stretching machine 40 or between the longitudinal stretching machine 40 and the lateral stretching machine 50.

### Operation of Feed Mechanism

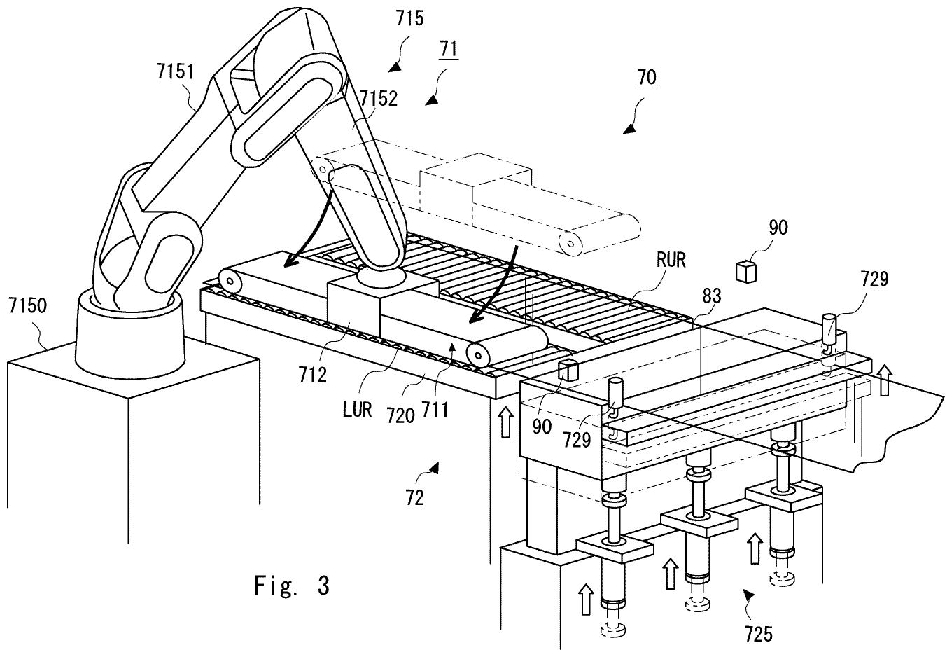

FIG. 3 is a schematic perspective view showing an operation of the film feed mechanism.

As shown in FIG. 3, the feed mechanism 70 causes the lower roll base 720 to move up, to thereby place the film 83 fed from an upstream side on the lower roll base 720. Then, the feed mechanism 70 causes the robot arm 715 to move the tip part thereof down, to thereby convey the film 83 toward a downstream side by rotation of the belt conveyor 711 while the film 83 is grasped between the belt conveyor 711 and the lower roll base 720.

As shown in FIG. 1, the film 83 fed from the longitudinal stretching machine 40 is fed to an upper part of the lower roll base 720 of a lower roller mechanism 72 along the guide rolls 729 and 729 provided at respective ends of the route. The elevation mechanism 725 is driven, then the lower roll base 720 moves up to a predetermined position, and the film 83 can be placed over the lower roll base 720. The film 83 moves toward the downstream side over the rolls of the lower roll base 720 by the longitudinal stretching machine 40. The rolls over the lower roll base 720 may include the plurality of lower right rolls RUR and the plurality of lower left rolls LUR arranged in two rows. Each of the rolls may be a driving roll driven by a driving source (not shown) or a free roll that does not include a driving source.

When the film 83 is fed to a predetermined position over the roll of the lower roll base 720 by the longitudinal stretching machine 40 (or the driving rolls), the robot arm 715 moves the belt conveyor 711 provided at the tip thereof down. Specifically, as shown in FIG. 3, the belt conveyor 711 is moved down substantially parallel to the plurality of lower right rolls RUR of the lower roll base 720, and grasps the film 83 between the belt conveyor 711 and the plurality of lower right rolls RUR. When the belt conveyor 711 drives the plurality of rolls 711R and 711R, the film 83 grasped by the belt 7111 and the plurality of lower right rolls RUR are fed to the downstream side. Note that when the plurality of lower right rolls RUR include driving sources, the plurality of lower right rolls RUR may be rotated in synchronization with the plurality of rolls 711R of the belt conveyor 711.

In FIGS. 2 and 3, one robot mechanism 71 corresponding to the plurality of lower right rolls RUR is shown, but another robot mechanism corresponding to the plurality of lower left rolls LUR may be provided. Alternatively, the robot mechanism 71 may include two of the branched second links 7152 and 7152 respectively corresponding to the plurality of lower right rolls RUR and the plurality of lower left rolls LUR. In some embodiments, a first conveyor corresponding to the plurality of left rolls and a second conveyor corresponding to the plurality of right rolls are provided on the lower side of the robot arm. In this case, each of the first conveyor and the second conveyor is configured to be rotatable with respect to the vertical axis.

As described above, wrinkles of a film may be stretched by feeding the film to the downstream side while grasping it between the plurality of lower right rolls RUR and the belt conveyor 711.

In some embodiments, the meandering detection unit 90 (e.g., various types of sensors such as a camera, a laser sensor, or an edge sensor) that detects whether meandering of a film is present may be provided above the lower roll base 720. For example, in FIG. 2, the meandering detection units 90 are edge sensors that detect respective ends of a film after the film has passed through the longitudinal stretching area. When meandering of the film is detected by the meandering detection units 90, the robot arm 715 may axially rotate the film 83 placed over the lower roll base 720 in the vertical direction while pressing it against the belt conveyor 711 based on a result of the detection. For example, when a film is meandering to the left with respect to a moving direction of the film, the robot arm 715 axially rotates the film 83 placed over the lower roll base 720 clockwise in the vertical direction while pressing it against the belt conveyor 711. By doing so, the meandering of the film can be corrected, and hence the subsequent operation for closing the clips by the clip closers 501 (FIG. 4) and stretching of the film in the lateral direction can be performed appropriately. Note that the operation of the robot arm 715 is controlled by a control unit (not shown). The control unit may receive sensor signals from various types of sensors such as the meandering detection unit 90, and may control, based on the sensor signals, various types of driving units related to the robot arm and the like so that they are driven. The control unit can execute various types of control based on various types of programs stored in a storage unit, and is implemented by a central processing unit (CPU), a read-only memory (ROM), a random access memory (RAM), an input/output port (I/O), etc.

FIG. 4 is a schematic perspective view showing a film feed mechanism and a clip apparatus according to another embodiment.

A clip apparatus 800 is disposed at both ends of a film after the above-described feed mechanism 70. In FIG. 4, although only the clip apparatus 800 for the left end of the film is shown, the clip apparatus 800 for the right end of the film may also be disposed substantially symmetrical thereto.

As described above, the feed mechanism 70 feeds a film to the positions of the clip closers 501 while grasping the film by means of the belt conveyor 711 and the lower roll base 720. One of the clip closers 501 closes the clips at one end of the grasped film. Then, the other of the clip closers 501 closes the clips at the other end of the grasped film. After the clip closers 501 and 501 respectively disposed on the left and the right sides close the clips at the respective ends of the film, the feed mechanism 70 can move the film to the downstream side. In this way, the feed mechanism 70 can assist a clip fastening operation performed by the clip closers for stretching of a film in the lateral direction. The above structure eliminates the need for a manual operation performed by a plurality of persons, and thus the film can be smoothly conveyed.

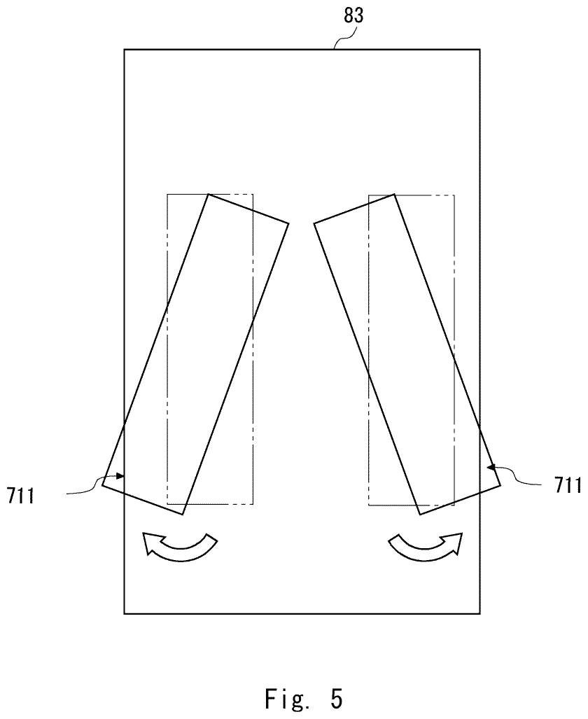

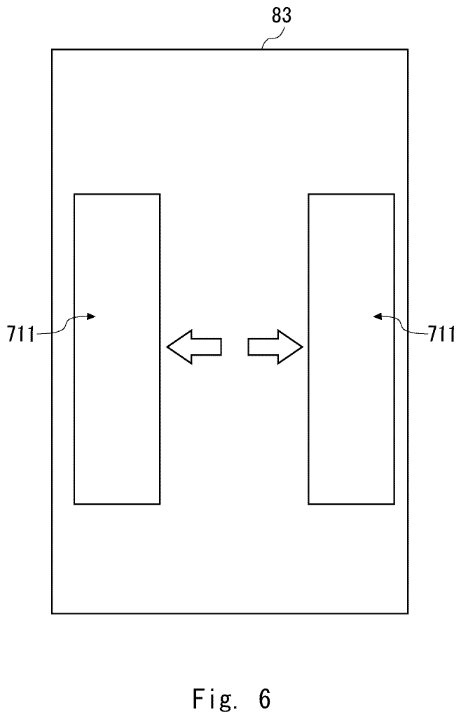

In some embodiments, a wrinkle detection unit 7121 (e.g., a camera) that detects wrinkles of the film 83 may be provided above the lower roll base 720 (e.g., below the attachment part 712 of the robot arm 715). The wrinkle detection unit 7121 (e.g., a camera or an edge sensor) may be provided in a place (e.g., ceiling) distant from the robot arm 715 and between the longitudinal stretching machine 40 and the robot arm 715. As shown in FIG. 5, the robot arm 715 may also axially rotate the film 83 placed over the lower roll base 720 in the vertical direction while pressing it against the belt conveyor 711 based on a captured image of the film. By doing so, local wrinkles of the film can be removed. In another embodiment, the two belt conveyors 711 and 711 respectively moves in the right and left directions as shown in FIG. 6 while holding the film, whereby wrinkles of the film can be removed. Note that wrinkles of the film may be removed by moving, while one of the two belt conveyors is fixed at a position near one edge of the film, only the other belt conveyor toward the other edge of the film. Note that the operation of the robot arm 715 is controlled by a control unit (not shown). The control unit receives sensor signals from various types of sensors such as the wrinkle detection unit 7121, and may control, based on the sensor signals, various types of driving units related to the robot arm and the like so that they are driven.

In the example described above, the program includes instructions (or software codes) that, in a case where it is loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (Registered Trademark) disc or other types of optical disc storage, a magnetic cassette, a magnetic tape, and a magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The present invention made by the inventors of the present application has been described above in a concrete manner based on embodiments. However, the present invention is not limited to the above-described embodiments, and needless to say, various changes can be made without departing from the spirit and scope of the present invention. For example, although a belt conveyor has been described in the above embodiments, a roll conveyor may instead be used. In order to stretch wrinkles of a film, it is preferable to use a belt conveyor.

In some embodiments, a film conveyance method is a film conveyance method for feeding a film from an upstream side to a downstream side by using a film conveyance machine including a robot arm that includes a conveyor on a lower side of a tip part of the robot arm, and a lower roll base that is provided below the film and includes a plurality of rolls, which lower roll base can move up and down, the film conveyance method including: causing the lower roll base to move up, thereby placing the film fed from the upstream side on the lower roll base; and causing the robot arm to move down, thereby conveying the film toward the downstream side by rotation of the conveyor while the film is grasped between the conveyor and the lower roll base.

In some embodiments, a film manufacturing apparatus includes: an extruder configured to melt a charged resin raw material and extrude the molten resin raw material; a die coupled to the extruder, the die being configured to mold a molten resin into a film shape; a cooling roll configured to cool the film-like molten resin extruded from the die and discharge a resin film obtained by solidification of the molten resin; a longitudinal stretching machine provided downstream of the cooling roll, the longitudinal stretching machine being configured to longitudinally stretch a film and feed the film toward a downstream side; a feed mechanism configured to feed the film to the downstream side, the feed mechanism including a robot arm that includes a conveyor on a lower side of a tip part of the robot arm, and a lower roll base that is provided below the conveyor and includes a plurality of rolls, which lower roll base can move up and down; and a lateral stretching machine provided downstream of the feed mechanism, the lateral stretching machine being configured to laterally stretch a film and feed the film toward the downstream side.

This application is based upon and claims the benefit of priority from Japanese patent application No. 2023-004857, filed on Jan. 17, 2023, the disclosure of which is incorporated herein in its entirety by reference.

### REFERENCE SIGNS LIST

1 FILM MANUFACTURING APPARATUS
10 EXTRUDER
11 CYLINDER
13 HOPPER
20 T-DIE
30 COOLER
40 LONGITUDINAL STRETCHING MACHINE
50 LATERAL STRETCHING MACHINE
60 WINDER
70 FEED MECHANISM
71 ROBOT MECHANISM
72 LOWER ROLLER MECHANISM
82a MOLTEN RESIN
83 FILM
90 MEANDERING DETECTION UNIT
501 CLIP CLOSER
711 BELT CONVEYOR
712 ATTACHMENT PART
720 LOWER ROLL BASE
725 ELEVATION MECHANISM
729 GUIDE ROLL
CR1 to CR4 COOLING ROLL
R1 to R11 ROLL
RL1, RL2 RAIL
RUR LOWER RIGHT ROLL
LUR LOWER LEFT ROLL

1. A film conveyance machine configured to feed a film from an upstream side to a downstream side, the film conveyance machine comprising a feed mechanism that comprises:
a robot arm comprising a conveyor on a lower side of a tip part of the robot arm; and
a lower roll base that is provided below the conveyor and includes a plurality of rolls.

2. The film conveyance machine according to claim 1, wherein
the feed mechanism is configured to:
place a film fed from the upstream side on the lower roll base; and
cause the robot arm to move the tip part thereof down, to thereby convey the film toward the downstream side by rotation of the conveyor while the film is grasped between the conveyor and the lower roll base.

3. The film conveyance machine according to claim 1, further comprising:
a longitudinal stretching machine provided in a longitudinal stretching area located upstream of the feed mechanism, the longitudinal stretching machine being configured to longitudinally stretch a film and feed the film toward the downstream side; and
a lateral stretching machine provided in a lateral stretching area located downstream of the feed mechanism, the lateral stretching machine being configured to laterally stretch a film and feed the film toward the downstream side.

4. The film conveyance machine according to claim 1, further comprising a wrinkle detection unit configured to detect a wrinkle of a film,
wherein the robot arm is configured to axially rotate the film placed over the lower roll base in a vertical direction while pressing the film against the conveyor based on a captured image of the film.

5. The film conveyance machine according to claim 1, further comprising a wrinkle detection unit configured to detect a wrinkle of a film,
wherein the robot arm is configured to move the conveyor toward a side end part of the film placed over the lower roll base while pressing the film against the conveyor based on a captured image of the film.

6. The film conveyance machine according to claim 3, further comprising a meandering detection unit configured to detect whether meandering of a film is present,
wherein the robot arm is configured to, when meandering of the film is detected, axially rotate the film placed over the lower roll base in the vertical direction while pressing the film against the conveyor based on a result of the detection.

7. The film conveyance machine according to claim 1, wherein in the lower roll base, the plurality of rolls are configured to be connected to driving sources and rotated in synchronization with the rotation of the conveyor.

8. The film conveyance machine according to claim 1, wherein
the lower roll base includes a plurality of left rolls and a plurality of right rolls respectively arranged in right and left directions, and
a first conveyor corresponding to the plurality of left rolls and a second conveyor corresponding to the plurality of right rolls are provided on a lower side of the robot arm, and each of the first conveyor and the second conveyor is configured to be rotatable with respect to a vertical axis.

9. A film conveyance method for feeding a film from an upstream side to a downstream side by using a film conveyance machine comprising a robot arm that comprises a conveyor on a lower side of a tip part of the robot arm, and a lower roll base that is provided below the conveyor and includes a plurality of rolls, the film conveyance method comprising:
placing the film fed from the upstream side on the lower roll base; and
causing the robot arm to move down, thereby conveying the film toward the downstream side by rotation of the conveyor while the film is grasped between the conveyor and the lower roll base.

10. A film manufacturing apparatus comprising:
an extruder configured to melt a charged resin raw material and extrude the molten resin raw material;
a die coupled to the extruder, the die being configured to mold a molten resin into a film shape;
a cooling roll configured to cool the film-like molten resin extruded from the die and discharge a resin film obtained by solidification of the molten resin;
a longitudinal stretching machine provided downstream of the cooling roll, the longitudinal stretching machine being configured to longitudinally stretch a film and feed the film toward a downstream side;
a feed mechanism configured to feed the film to the downstream side, the feed mechanism comprising a robot arm that comprises a conveyor on a lower side of a tip part of the robot arm, and a lower roll base that is provided below the conveyor and includes a plurality of rolls; and
a lateral stretching machine provided downstream of the feed mechanism, the lateral stretching machine being configured to laterally stretch a film and feed the film toward the downstream side.
